(19) United States
(12) Patent Application Publication
(10) Pub. No.: US 2010/0294704 A1
(43) Pub. Date: Nov. 25, 2010

(54) DRAINING-FILTERING DEVICE AND TREATING DEVICE FOR BIO-TOILET

(76) Inventor: Andy Mingfen Tung, Guangdong (CN)

Correspondence Address: GREER, BURNS & CRAIN, 300 S WACKER DR, 25TH FLOOR, CHICAGO, IL, 60606, US

(21) Appl. No.: 12/301,894

(22) PCT Filed: May 22, 2006
(86) PCT No.: PCT/CN07/01654

§ 371 Date: Nov. 21, 2008

(30) Foreign Application Priority Data
May 22, 2006 (CN) 200610078296.4

(51) Int. Cl. E03D 9/10; B01D 29/00

(52) U.S. Cl. 210/153

(57) ABSTRACT

A draining-filtering device for a water closet, includes a trough for holding stuffs and excretion, in which at least a stirring device is arranged, each stirring device having a pivot and a stirring part, the draining-filtering device is placed under the bottom of the treating trough, which includes at least one liquid-draining trough for draining excessive liquid in the treating trough and arranged at the bottom of the treating trough, at least one liquid-conducting trough for holding the liquid drained off from the liquid-draining trough arranged under the bottom of the treating trough with respect to the liquid-draining trough, and at least one filtering device for filtering the stuffs and excretion in the filtering through covered over the liquid-draining trough arranged in accordance with the liquid-draining trough.

### FIELD OF THE INVENTION

The present invention relates to a bio-toilet, particularly to a draining-filtering device, as well as a treating device, for a bio-toilet.

### BACKGROUND OF THE INVENTION

With the increase of the environmental awareness, much attention has been paid to the treatment of human or animal's excretions. Varieties of bio-toilets have thus been developed and applied. Japanese invention patent No. 3160859 discloses a bio-toilet, which is shown in FIGS. 1A-1C. Human excretions, such as feces and urines, drop directly into a treating device 10 of the toilet of the prior art. The treating device firstly includes a treating trough 12, through which a rotating shaft 14 driven by a motor 16 is laid. A blade 18 is fixed on the rotating shaft 14. On one hand, the blade 18 stirs the excretion and stuffs with the shaft rotating, while on the other hand the blade 18 can transport the treated excretion away from the inlet of the toilet. An auxiliary heater 11 is used to adjust temperature so as to ensure a generally constant temperature in the treating trough 12, and provide a best condition for the microbes dissolving the excretion. Thus, when a fully mixing of the stuffs and the excretion, the organic substances in the excretion will, after a period of time, be fully dissolved to become organic manures. In practice, however, the treating trough with a single stirring device may cause hardenings in a relatively large area of its upper part.

Another treating device 100 for bio-toilet is disclosed in Chinese patent application No. 200480002144.5, which, as shown in FIGS. 2A and 2B, includes a treating trough 102 for holding sawdust and excretion and two rotating devices 104a, 104b arranged inside the treating trough 102. Each rotating device 104(a, b) includes a pivot 106 and stirring parts 108. The stirring part 108 is fixed to the pivot 106 by means of a plurality of supporting racks with the pivot 106 as the central axis. The stirring parts distributed on both ends of the pivot of each rotating device are arranged in a way of rotating oppositely with each other, so that the stirring parts will move the sawdust from the ends to the center as the rotating device rotates, solving thus the problem of large-area hardenings. Particularly, the stirring parts of the two stirring devices 104a and 104b are partly overlapped in favor of reducing the inaccessible area and effectively avoiding the phenomenon of hardening.

However, a big problem for those bio-toilets of the prior art when treating the feces is the limitation of usage frequencies (within a certain period of time). In particularly, the bio-toilet of the prior art may be used by many participants in a very short time when a large-scale public activity is held. When the rated usage frequency is exceeded, the feces in the treating trough cannot be fully dissolved by the microbes, and the treating effect will be affected gravely. At the same time, liquid in the trough may be excessive due to the excretions cannot be dissolved and evaporated in time, which will kill many useful microbes and result in the reduced dissolving speed, while the reduced dissolving speed causes a lower dissolving capability and a vicious circle. Ultimately, the treating trough will soon become unusable with the stuff (the sawdust) needing to be replaced.

To solve the above-mentioned problem of limited utilization, there is another way in the prior art that a larger treating trough should be used. However, that cannot solve the problem thoroughly, and the larger trough will not only occupy more space, but also causes many inconveniences in transportation and maintenance. Thus, it is an urgent problem need to be solved that, when the usage frequency of the bio-toilet is exceeded, how to drain off timely the excessive liquid in the treating trough to prolong the stuff-replacing circle of the bio-toilet and to ensure the treating effect of the excretions. In addition, it is also a problem need to be considered that how to reduce the rated usage limitation while ensure the treating effect, in the case of the treating trough having a small volume is used.

### SUMMARY OF THE INVENTION

It is the objective of the present invention to provide a draining-filtering device, as well as a treating device for bio-toilet, which can drain off timely the excessive liquid in the bio-toilet to allow the microbes in the treating trough work better in best temperature and humidity, so as to ensure the quality of excretion treatment.

In order to realize the above objectives, a draining-filtering device for a bio-toilet is provided by the present invention. The bio-toilet comprises a trough for holding stuffs and excretions, in which at least one stirring device is arranged. Each stirring device has a pivot and a stirring part fixed thereon. The draining-filtering device is placed under the bottom of the treating trough, and comprises: at least one liquid-draining trough for draining excessive liquid in the treating trough, which is arranged at the bottom of the treating trough; at least one liquid-conducting trough for holding the liquid drained from the liquid-draining trough, which is arranged under the bottom of the treating trough correspondingly to the liquid-draining trough; and at least one filtering device for filtering the stuffs and the excretions in the treating trough, which is covered over the liquid-draining trough and arranged correspondingly to the liquid-draining trough.

Said draining-filtering device is characterized in that the filtering device is filtering plate having a plurality of filtering holes distributed therein.

Said draining-filtering device is characterized in that the filtering hole has a diameter of about 0.01 mm-0.8 mm.

Said draining-filtering device is characterized in that one end of the filtering plate protrudes from one end of the liquid-conducting trough by a predefined length to form a manipulating part.

Said draining-filtering device is characterized in that the filtering device is a filtering net having a net hole diameter of about 0.01 mm˜0.8 mm.

Said draining-filtering device is characterized in that the filtering device comprises: at least one supporting cover having a plurality of through holes therein; and a filtering net, spread flatly over the outer surface of said supporting cover and having a net hole diameter less than a through hole diameter of the supporting cover.

Said draining-filtering device is characterized in that the through hole diameter is about 0 mm.

Said draining-filtering device is characterized in that the through hole diameter is less than about 50 mm.

Said draining-filtering device is characterized in that the net hole diameter of the filtering net is about 0.01 mm˜0.8 mm.

Said draining-filtering device is characterized in that the liquid-conducting trough is a trough having an opening at its at least one end and is composed of a bottom wall, two sides connected with two sides of the bottom wall and an end wall.

Said draining-filtering device is characterized in that both sides of the supporting cover are arranged with a joining member respectively, each joining member being arranged with a rabbet that is engaged with the top of the respective side wall of the liquid-conducting trough.

Said draining-filtering device is characterized in that both sides of the filtering net further extend along the joining members at both sides of the supporting cover to be engaged into the rabbets, the rabbets together with the filtering net being engaged with the tops of the side walls of the liquid-conducting trough.

Said draining-filtering device is characterized in that one end of the supporting cover protrudes from one end of the liquid-conducting trough by a predefined length to form a manipulating part.

Said draining-filtering device is characterized in that it further comprises: a pair of guides arranged oppositely at both sides of the liquid-draining trough. Each guide includes: a fixing part for being fixed to the bottom of the treating trough; and a supporting part for supporting the liquid-conducting trough, which is arranged so as to extend inwardly towards the liquid-draining trough.

Said draining-filtering device is characterized in that the treating trough has two liquid-draining troughs, under each of which one liquid-conducting trough is arranged correspondingly, each liquid-conducting trough being supported and fixed by one respective pair of guides.

Said draining-filtering device is characterized in that both the liquid-draining trough and the liquid-conducting trough are arranged along the direction of the pivot.

To realize the above-mentioned objective, a treating device for a bio-toilet is also provided by the invention. Said treating device comprises: a treating trough for holding stuffs and excretions; and at least one stirring device, arranged inside the treating trough, for mixing the stuffs and the excretions, each stirring device having a pivot and a stirring part fixed on the pivot by means of a plurality of supporting racks. It is characterized that the treating device further comprises a draining-filtering device arranged under the bottom of the treating trough. Said draining-filtering device comprises: at least one liquid-draining trough for draining the excessive liquid in the treating trough, which is arranged at the bottom of the treating trough; at least one liquid-conducting trough for holding the drained liquid from the liquid-draining trough, which is arranged under the bottom of the treating trough correspondingly to the liquid-draining trough; and at least one filtering device for filtering the stuffs and the excretion in the treating trough, which is covered over the liquid-conducting trough and arranged correspondingly to the liquid-draining trough.

Said treating device is characterized in that the filtering device is a filtering plate having a plurality of filtering holes distributed therein.

Said treating device is characterized in that the filtering hole has a diameter of about 0.01 mm˜0.8 mm.

Said treating device is characterized in that one end of the filtering plate protrudes from one end of the liquid-conducting trough by a predefined length to form a manipulating part.

Said treating device is characterized in that the filtering device is a filtering net having a net hole diameter of about 0.01 mm˜0.8 mm.

Said treating device is characterized in that the filtering device comprises: at least one supporting cover, having a plurality of through holes therein; and a filtering net, spread flatly over the outer surface of the supporting cover, and having a net hole diameter less than the through hole diameter of the supporting cover.

Said treating device is characterized in that the through hole diameter is 0 mm.

Said treating device is characterized in that the through hole diameter is less than about 50 mm.

Said treating device is characterized in that the net hole diameter of the filtering net is about 0.01 mm˜0.8 mm.

Said treating device is characterized in that the liquid-conducting trough is a trough having an opening at its at least one end and is composed of a bottom wall, two side walls connected to two sides of the bottom wall and an end wall.

Said treating device is characterized in that both sides of the supporting cover are arranged with a joining member respectively, each joining member being arranged with a rabbet that is engaged with the top of the respective side wall of the liquid-conducting trough.

Said treating device is characterized in that both sides of the filtering net further extend along the joining member at both sides of the supporting cover to be engaged into the rabbets, the rabbets together with the filtering net being engaged with the tops of the side walls of the liquid-conducting trough.

Said treating device is characterized in that one end of the supporting cover protrudes from one end of the liquid-conducting trough by a predefined length to form a manipulating part.

Said treating device is characterized in that the draining-filtering device further comprises a pair of guides arranged oppositely at both sides of the liquid-draining trough. Each guide includes: a fixing part for being fixed to the bottom of the treating trough; and a supporting part for supporting the liquid-conducting trough, which is arranged so as to extend inwardly towards the liquid-draining trough.

Said treating device is characterized in that the treating trough has two the liquid-draining troughs, under each of which one liquid-conducting trough is arranged correspondingly, each liquid-conducting trough being supported and fixed by one respective pair of guides.

Said treating device is characterized in that both the liquid-draining trough and the liquid-conducting trough are arranged along the direction of the pivot.

Said treating device is characterized in that the treating trough has two sunken parts arranged in parallel, said liquid-draining trough is arranged at the bottom of each sunken part.

According to one aspect of the invention, through arranging a liquid-draining trough at the bottom of the treating trough and through arranging the filtering device and the liquid-conducting trough under the liquid-draining trough, excessive liquid in the treating trough can be drained off from the liquid-conducting trough timely after being filtered by the filtering device, avoiding thus the ineffectiveness of the stuffs in the treating trough.

According to another aspect of the invention, since the draining-filtering device according to the invention can drain off timely the excessive liquid in the trough, for a small-volume treating trough, it suits to the feature of small volume, and increases the usage frequencies as well, ensuring thus the treating effect and benefiting the maintenance and rapid transportation.

According to one further aspect, when it is necessary to replace the stuffs in the treating trough, the filtering device and the liquid-conducting trough can be drawn out and the stuffs can be drained off by the liquid-draining trough.

The invention will be now described in details in accompaniment with drawings and preferred embodiments, which, however, will not be used as a limitation to the invention.

### BRIEF DESCRIPTION OF THE DRAWINGS

FIGS. 1A-1C are respectively schematic drawings of the structure of a bio-toilet of the prior art, showing a treating trough with a stirring device.

FIGS. 2A-2C are respectively schematic drawings of the structure of another bio-toilet of the prior art, showing a treating trough with two stirring device.

FIG. 3A is a schematic drawing of the structure of the treating device of a bio-toilet with a draining-filtering device according to the present invention, showing the arrangement position of a liquid draining trough.

FIG. 3B is the schematic drawing of the structure of the treating trough of the treating device in FIG. 3A, showing the structure of the liquid-draining trough.

FIG. 3C is a cross-sectional view of the end of the treating device in FIG. 3A, showing the mounting position of the draining-filtering device.

FIG. 4A is a schematic drawing of the structure of a preferred embodiment of the guide in the draining-filtering device according to the present invention.

FIG. 4B is a schematic drawing of the structure of another preferred embodiment of the guide in the draining-filtering device according to the present invention.

FIG. 4C is a schematic drawing of the structure of a preferred embodiment of the filtering device in the draining-filtering device according to the present invention, wherein the filtering device is a filtering plate.

FIG. 4D is a schematic drawing of the structure of a preferred embodiment of the liquid-conducting trough in the draining-filtering device according to the invention.

FIG. 5A is a perspective drawing of another preferred embodiment of the filtering device in the draining-filtering device according to the present invention, wherein one end of the filtering plate forms a manipulating part.

FIG. 5B is an end view before the installation of the filtering device with the liquid-conducting trough according to the invention.

FIG. 5C is an end view after the installation of the filtering device with the liquid-conducting trough according to the invention.

FIG. 5D is a magnified schematic view of the structure of the part A in FIG. 5B, showing the engagement structures of the supporting cover and the filtering net in the filtering device and the structure of the supporting cover matching with the top of the side plate of the liquid-conducting trough.

FIG. 6 is a schematic drawing of the structure of another preferred embodiment of the filtering device in the draining-filtering device according to the invention.

FIG. 7A is a schematic drawing of the structure of the treating trough of the bio-toilet according to the present invention after the installation of the pair of guides at the bottom of the treating trough.

FIG. 7B is a schematic drawing of the structure of the draining-filtering device mounted on pairs of guides.

FIG. 8 is a schematic drawing of another applied structure of the draining-filtering device according to the present invention, showing the structure of the draining-filtering device mounted at the bottom of a treating trough with the single stirring device.

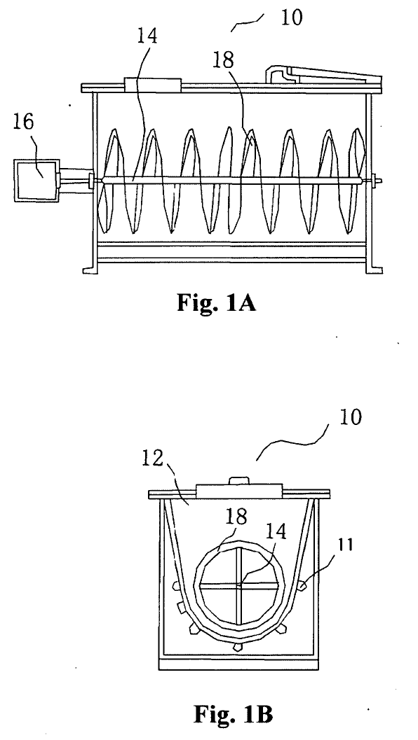

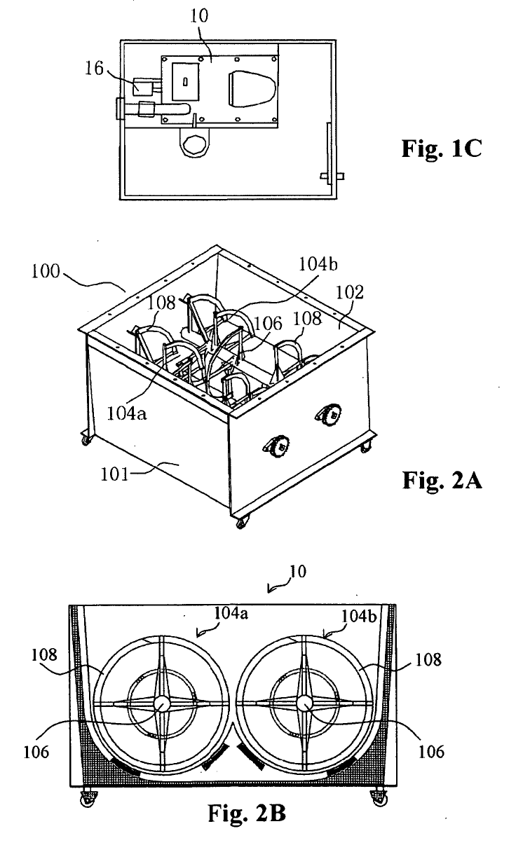

### DETAILED DESCRIPTION OF THE PREFERRED EMBODIMENT

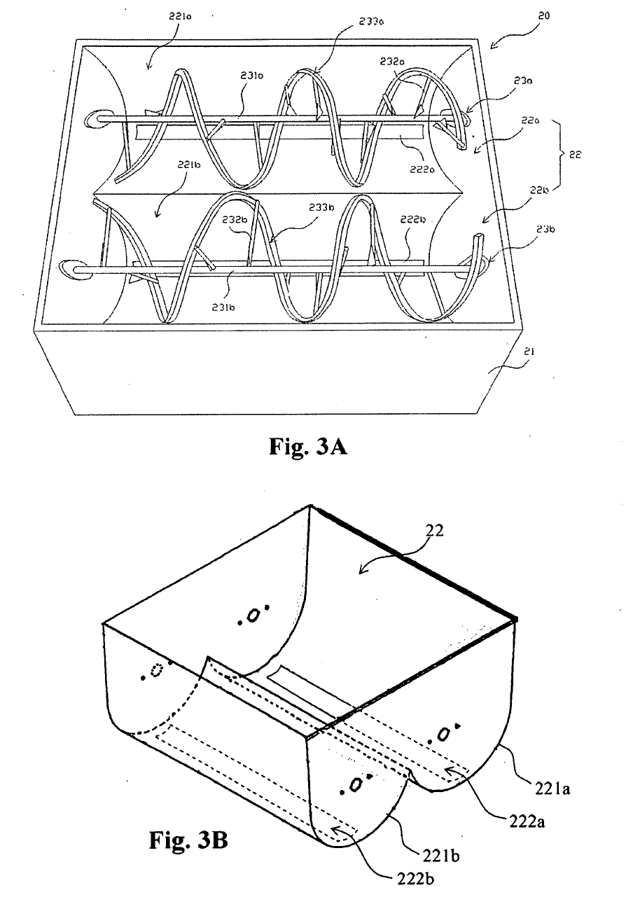

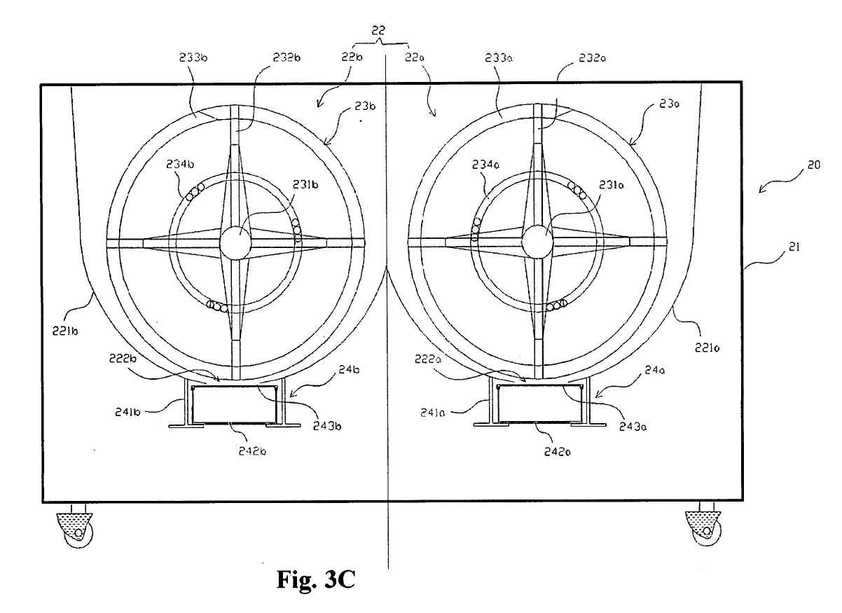

FIG. 3A shows a treating device 20 of a bio-toilet according to the invention, which has a draining-filtering device. The treating device 20 includes a housing 21 and a treating trough 22, for example two treating troughs 22a and 22b arranged in parallel, for holding stuffs and excretions. Two stirring devices 23a and 23b are arranged in the treating trough in parallel. The stirring devices 23a and 23b each has a pivot 231a/231b and a stirring member 233a/233b that is arranged spirally. The stirring members 233a and 233b are fixed on the respective pivots 231a and 231b through supports 232a and 232b respectively. The pivots 231a and 231b can be driven by motors (not shown) to bring the respective stirring devices 23a and 23b into rotation, so that the stuffs in the trough can be fully stirred. Furthermore, according to the present invention, preferably, two sunken parts 221a and 221b are respectively formed at the bottoms of the treating troughs 22a and 22b corresponding to the stirring devices 23a and 23b. Two liquid-draining troughs 222a and 222b are arranged in the sunken parts 221a and 221b respectively, while a draining-filtering device (not shown in FIG. 3A) is arranged correspondingly under the liquid-draining troughs 222a and 222b, respectively. Thus, when liquid in the treating trough 22 is excessive, the liquid can be directly drained from the draining-filtering device. On the other hand, the liquid absorbed in the stuffs (sawdust) can be extruded by the stirring device(s) during stirring process and then be drained from the draining-filtering device, which raises the usage life of the stuffs and prolongs the stuff-replacing circle for the treating trough.

FIG. 3B shows the positions of the liquid-draining troughs 222a and 222b according to the present invention. The liquid-draining troughs 222a and 222b are deployed preferably along the direction of the pivots and are arranged at the lowest portion of two sunken parts 221a and 221b of the treating trough 22, respectively. The liquid-draining troughs can be used for draining and replacing the stuffs in the treating trough.

FIG. 3C shows the mounting positions of the draining-filtering devices 24a and 24b according to the invention. The draining-filtering devices 24a and 24b are arranged under the bottoms of the sunken parts 221a and 221b, which include the liquid-draining troughs 222a and 222b respectively disposed on the bottoms of the sunken parts 221a and 221b of the treating trough 22, for draining excessive liquid within said treating trough 22; two liquid-conducting troughs 242a and 242b arranged under the bottom of the treating trough 22 with respect to the liquid-draining troughs 222a and 222b, for holding and conducting the drainage of the liquid from the liquid-draining troughs 222a and 222b; and two filtering devices 243a and 243b, covered over the liquid-conducting troughs 242a and 242b and arranged with respect to the liquid-draining troughs 222a and 222b, for filtering the stuffs and excretions in the treating trough 22. Preferably, the liquid-conducting troughs 242a and 242b as well as the filtering devices 243a and 243b are correspondingly arranged under the liquid-draining troughs 222a and 222b respectively, while the liquid-conducting troughs 242a and 242b are respectively supported and fixed with pairs of guides 241a and 241b that are arranged at both sides of the liquid-draining troughs 222a and 222b respectively. Of course, the liquid-conducting troughs can be fixed directly on the bottom of the treating trough. Preferably, both the liquid-conducting troughs 242a and 242b and the filtering devices 243a and 243b can be arranged along the direction of the pivots respectively, correspondingly to the liquid-draining troughs 222a and 222b. Thus, when there is excessive liquid in the trough, the liquid can be filtered by the filtering devices 243a and 243b and can be drained from the liquid-draining troughs 222a and 222b into the liquid-conducting troughs 242a and 242b and then drained out off. Thus, through draining the excessive liquid within the treating trough in time and the cooperation with two stirring devices 23a and 23b and two end rings 234a and 234b arranged on the ends of the pivots 231a and 231b, it is possible to realize not only a full stirring in the treating device but also a smash of the hardenings in the trough, which keeps the stuffs in the trough in an optimized working condition all the time so as to reach the best treating effect.

In this embodiment, the liquid-draining trough, the filtering device, the liquid-conducting trough and the pair of guides correspond with each other, i.e. one filtering device, one liquid-conducting trough and one pair of guides being placed under each liquid-draining trough. However, it should be understandable that one larger filtering device and one larger liquid-conducting trough can be disposed under two liquid-draining troughs for accepting the excessive liquid drained from both of the liquid-draining troughs while the larger liquid-conducting trough can be supported by one pair of guides, which, however, won't be used as the limitation to the invention.

The structures and the variations of each parts of the draining-filtering device according to the invention will now be described in details.

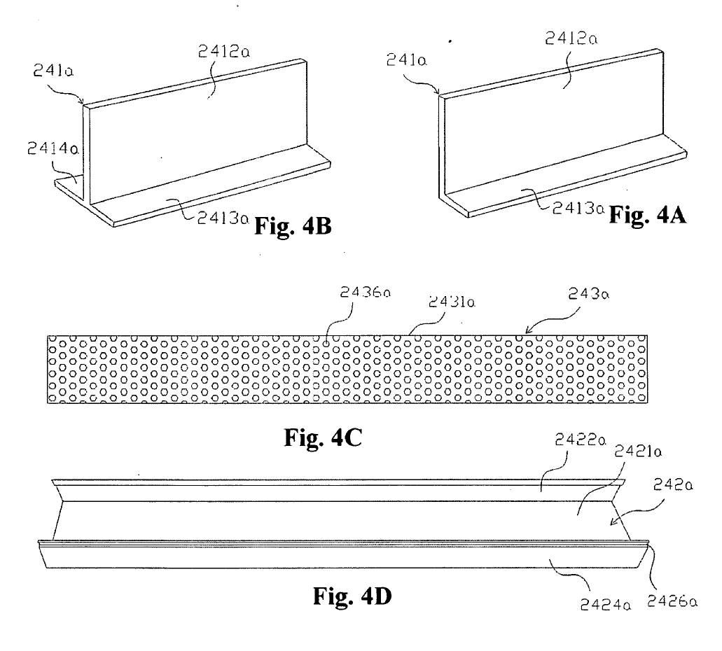

FIG. 4A shows the structure of the pair of guides 241a of the draining-filtering device according to the invention. Each of guides 241a contains a fixing member 2412a and a supporting member 2413a. The fixing member 2412a is fixed on the bottom of the treating trough at its one end and connected perpendicularly with the supporting member 2413a at it's the other end. The supporting member 2413a extends inwardly towards the liquid-draining trough for supporting the filtering device, allowing the liquid-conducting trough to slide along the supporting surface of the supporting member 2413a and to be inserted into and installed between the pair of guides 241a.

However, as shown in FIG. 4B, the supporting part 2413a of the guide 241a can be further extend outwardly towards the liquid-draining trough to form another extended part 2414a, which will not be used as a limitation to the invention.

FIG. 4C shows a preferred embodiment of the filtering device 243a according to the invention. According to this embodiment, the filtering device 243a can be a hard-material filtering plate 2431a that has a plurality of filtering holes 243a therein for filtering the stuffs in the trough, said filtering holes having a preferred diameter of about 0.01 mm˜0.8 mm.

FIG. 4D shows a preferred embodiment of the liquid-conducting trough 242a according to the invention. According to this embodiment, the liquid-conducting trough 242a is a trough with at least one opening at its one end, which is formed by a bottom wall 2421a, two side walls 2422a and 2424a respectively connected at the two sides of the bottom wall 2421a, and an end wall 2423a at one end portion. However, the liquid-conducting trough 242a can be a trough having openings at its two ends. Furthermore, the liquid-conducting trough 242a has a length corresponding to the length of the filtering plate 243a in FIG. 4C. Preferably, clipping parts 2426a can be further arranged on the tops of the two side walls 2422a and 2424a of the liquid-conducting trough 242a, which match with the clipping parts (not shown) at the sides of the filtering plate 243a so as to be connected together closely.

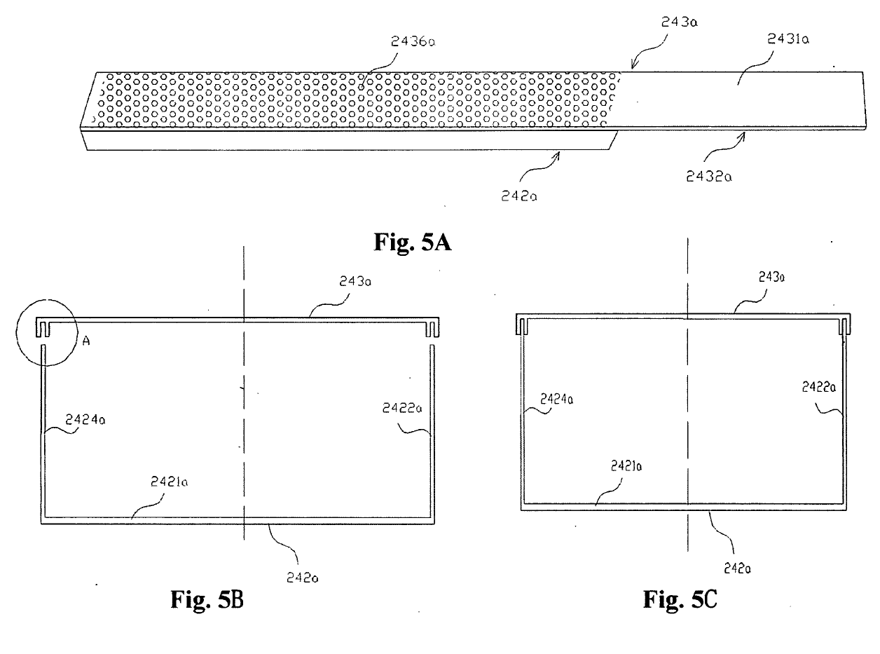

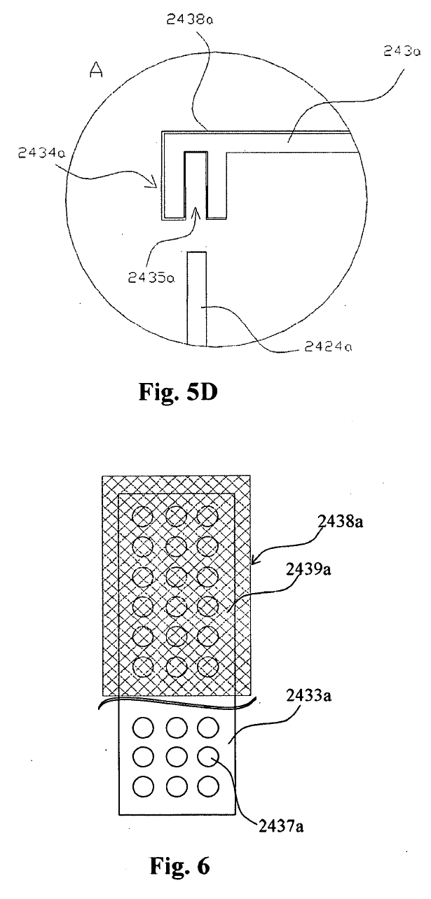

FIG. 5A shows another preferred embodiment of the filtering device according to the invention, in which one end of the filtering plate 2431a keeps substantially flush with one end of the liquid-conducting trough 242a while the other end of the filtering plate 2431a protrudes from the liquid-conducting trough 242a so as to form a manipulating part 2432a for drawing and replacing the filtering device 243a during maintenance conveniently. It can further be seen from FIG. 5A that the filtering holes 2436a in the filtering plate 2431a are arranged only in the area corresponding to the liquid-conducting trough 242a.

As shown in FIGS. 5B, 5C and 5D, joining members 2434a are arranged at both sides of the filtering device 243a, each of which is arranged with a rabbet 2435a. When the filtering device 243a being installed to the liquid-conducting trough 242a, the assemblage of them can be realized through the engagement of the tops of the side walls 2422a, 2424a of the liquid-conducting trough 242a with the respective joining members 2434a at the sides of the filtering device 243a. FIGS. 5B and 5C are respectively schematic drawings showing the filtering device 243a and the liquid-conducting trough 242a before and after their assembly.

FIG. 6 shows another preferred embodiment of the filtering device according to the invention. According to this embodiment, the filtering device includes a supporting cover 2433a having through holes 2437a with diameters of about 0 mm˜50 mm, and a filtering net 2438a spread flatly over the outer surface of the supporting cover 2433a. Net holes 2439a in the filtering net 2438a have a diameter less than the diameter of the through hole 2437a in the supporting cover 2433a, and preferably between about 0.01 mm˜0.8 mm. Particularly, when the filtering device is used in a place with low usage frequency, the diameter of the through holes can be 0. That is, the filtering device and the liquid-dumping device can be unused in the place with low usage frequency, and only when the liquid-draining trough is needed for stuff replacing, will the supporting cover 2433a be drawn out to allow the mixture inside the treating trough to be drained from the liquid-draining trough through the stirring of the stirring device so as to realize stuff replacement. Furthermore, as shown in FIG. 5D, both sides of the filtering net 2438a extend further along the joining members 2434a at both sides of the supporting cover 2433a and are engaged into the rabbets 2435a. Said rabbets 2435a, together with the filtering net 2438a, are engaged with the tops of the side walls 2424a of the liquid-conducting trough.

In the present invention, the filtering device 243a is not limited to the above-mentioned structures. It is understandable that other devices which can satisfy a filtering requirement can also be used in the draining-filtering device of the invention, such as a filtering net, which, however, can not be used as the limitation to the invention.

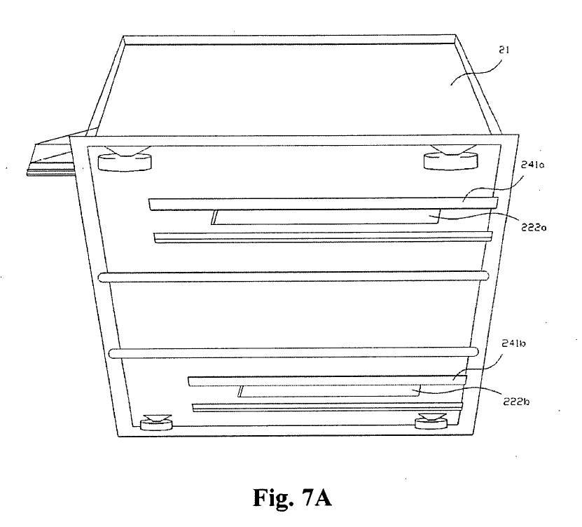

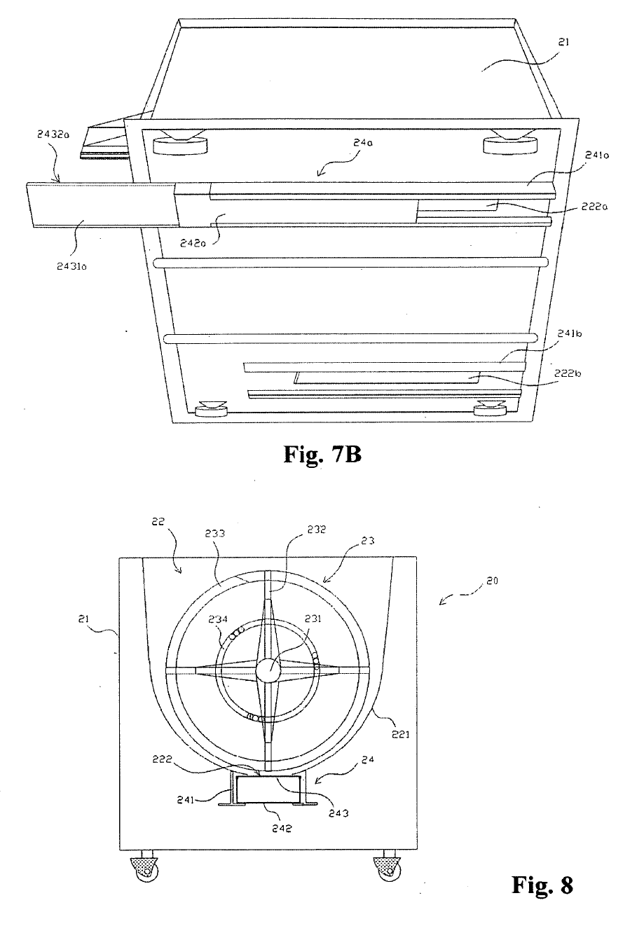

FIG. 7A shows the structures and the mounting positions of the pair of guides 241a/241b and the liquid-draining trough 222a/222b under the bottom of the treating trough according to the invention. FIG. 7B shows the process of installing the draining-filtering device 24a according to the invention. During the installation, the filtering plate 2431a and the liquid-conducting trough 242a are firstly assembled together. Then, they slide inside along the pair of guides 241a conveniently by means of the manipulating part 2432a on one end of the filtering plate 2431a, and mounted under the liquid-draining trough 222a. Thus, the excessive liquid in the treating trough can be drained from the liquid-draining trough, flowing into the liquid-conducting trough 242a after being filtered by the filtering holes in the filtering plate 2431a, and then be introduced to be drained out.

FIG. 8 shows the structure of the draining-filtering device 24 according to the invention applied in the treating device 20 having a single stirring device 23. Said treating device 20 similarly comprises a housing 21, a treating trough 22, a stirring device 23 and a draining-filtering device 24. The stirring device 23 includes a pivot 231, a stirring member 233 which is spirally arranged and mounted on the pivot 231 through a supporting rack 232. End rings 234 equipped with smashing blocks can be arranged on both ends of the pivot 231. Said draining-filtering device, as described a bove, can be composed of a liquid-draining trough 222, a pair of guides 241, a liquid-conducting trough 242 and a filtering device 243.

Although several preferred embodiments of the present invention have been described, the present invention may be used with other configurations. It will be appreciated by those skilled in the art that, the present invention could have many other embodiments, and changes and modifications may be made thereto without departing from the invention in its broader aspects and as set forth in the following claims and equivalents thereof.

### INDUSTRIAL APPLICATION

The present invention allows the excessive liquid in the bio-toilet to be drained out timely so as to give a full play to the microbes in said treating trough, ensuring thus a better effect for treating the excretions. Further, the stuff-replacing function can be realized by means of the liquid-draining trough of the invention.

What is claimed is:

1. A draining-filtering device for a bio-toilet, said bio-toilet comprising a trough for holding stuffs and excretions, in which at least one stirring device is arranged, each stirring device having a pivot and a stirring part fixed thereon,
wherein the draining-filtering device is placed under the bottom of the treating trough, and comprises:
at least one liquid-draining trough for draining excessive liquid in the treating trough, which is arranged at the bottom of the treating trough;
at least one liquid-conducting trough for holding the liquid drained from the liquid-draining trough, which is arranged under the bottom of the treating trough correspondingly to the liquid-draining trough; and
at least one filtering device for filtering the stuffs and the excretions in the treating trough, which is covered over the liquid-draining trough and arranged correspondingly to the liquid-draining trough.

2. The draining-filtering device according to claim 1, wherein the filtering device is filtering plate having a plurality of filtering holes distributed therein.

3. The draining-filtering device according to claim 2, wherein the filtering hole has a diameter of about 0.01 mm˜0.8 mm.

4. The draining-filtering device according to Claim 2, wherein one end of the filtering plate protrudes from one end of the liquid-conducting trough by a predefined length to form a manipulating part.

5. The draining-filtering device according to claim 1, wherein the filtering device is a filtering net having a net hole diameter of about 0.01 mm˜0.8 mm.

6. The draining-filtering device according to claim 1, wherein the filtering device comprises:
at least one supporting cover, having a plurality of through holes therein; and
a filtering net, spread flatly over the outer surface of the supporting cover and having a net hole diameter less than a through hole diameter of the supporting cover.

7. The draining-filtering device according to claim 6, wherein the through hole diameter is about 0 mm.

8. The draining-filtering device according to claim 6, wherein the through hole diameter is less than about 50 mm.

9. The draining-filtering device according to claim 6, wherein the net hole diameter of the filtering net is about 0.01 mm˜0.8 mm.

10. The draining-filtering device according to claim 6, wherein the liquid-conducting trough is a trough having an opening at its at least one end and is composed of a bottom wall, two sides connected with two sides of the bottom wall and an end wall.

11. The draining-filtering device according to claim 10, wherein both sides of the supporting cover are arranged with a joining member respectively, each joining member being arranged with a rabbet that is engaged with the top of the respective side wall of the liquid-conducting trough.

12. The draining-filtering device according to claim 11, wherein both sides of the filtering net further extend along the joining members at both sides of the supporting cover to be engaged into the rabbets, the rabbets together with the filtering net being engaged with the tops of the side walls of the liquid-conducting trough.

13. The draining-filtering device according to claim 12, wherein one end of the supporting cover protrudes from one end of the liquid-conducting trough by a predefined length to form a manipulating part.

14. The draining-filtering device according to claim 1, further comprising:
a pair of guides arranged oppositely at both sides of the liquid-draining trough, each guide includes:
a fixing part for being fixed to the bottom of the treating trough; and
a supporting part for supporting the liquid-conducting trough, which is arranged so as to extend inwardly towards the liquid-draining trough.

15. The draining-filtering device according to claim 14, wherein the treating trough has two liquid-draining troughs, under each of which one liquid-conducting trough is arranged correspondingly, each liquid-conducting trough being supported and fixed by one respective pair of guides.

16. The draining-filtering device according to Clam 1, wherein both the liquid-draining trough and the liquid-conducting trough are arranged along the direction of the pivot.

17. A treating device for a bio-toilet, comprising:
a treating trough for holding stuffs and excretions; and
at least one stirring device, arranged inside the treating trough, for mixing the stuffs and the excretions, each stirring device having a pivot and a stirring part fixed on the pivot by means of a plurality of supporting racks,
wherein the treating device further comprises a draining-filtering device arranged under the bottom of the treating trough, said draining-filtering device comprises:
at least one liquid-draining trough for draining the excessive liquid in the treating trough, which is arranged at the bottom of the treating trough;
at least one liquid-conducting trough for holding the drained liquid from the liquid-draining trough, which is arranged under the bottom of the treating trough correspondingly to the liquid-draining trough; and
at least one filtering device for filtering the stuffs and the excretion in the treating trough, which is covered over the liquid-conducting trough and arranged correspondingly to the liquid-draining trough.

18. The treating device according to claim 17, wherein the filtering device is a filtering plate having a plurality of filtering holes distributed therein.

19. The treating device according to claim 18, wherein the filtering hole has a diameter of about 0.01 mm˜0.8 mm.

20. The treating device according to claim 18, wherein one end of the filtering plate protrudes from one end of the liquid-conducting trough by a predefined length to form a manipulating part.

21. The treating device according to claim 17, wherein the filtering device is a filtering net having a net hole diameter of about 0.01 mm˜0.8 mm.

22. The treating device according to claim 17, wherein the filtering device comprises:
at least one supporting cover, having a plurality of through holes therein; and
a filtering net, spread flatly over the outer surface of the supporting cover, and having a net hole diameter less than the through hole diameter of the supporting cover.

23. The treating device according to claim 22, wherein the through hole diameter is 0 mM.

24. The treating device according to claim 22, wherein the through hole diameter is less than about 50 mm.

25. The treating device according to claim 22, wherein the net hole diameter of the filtering net is about 0.01 mm˜0.8 mm.

26. The treating device according to claim 22, wherein the liquid-conducting trough is a trough having an opening at its at least one end and is composed of a bottom wall, two side walls connected to two sides of the bottom wall and an end wall.

27. The treating device according to claim 26, wherein both sides of the supporting cover are arranged with a joining member respectively, each joining member being arranged with a rabbet that is engaged with the top of the respective side wall of the liquid-conducting trough.

28. The treating device according to claim 27, wherein both sides of the filtering net further extend along the joining member at both sides of the supporting cover to be engaged into the rabbets, the rabbets together with the filtering net being engaged with the tops of the side walls of the liquid-conducting trough.

29. The treating device according to claim 28, wherein one end of the supporting cover protrudes from one end of the liquid-conducting trough by a predefined length to form a manipulating part.

30. The treating device according to claim 17, wherein the draining-filtering device further comprises:
a pair of guides arranged oppositely at both sides of the liquid-draining trough, each guide including
a fixing part for being fixed to the bottom of the treating trough; and
a supporting part for supporting the liquid-conducting trough, which is arranged so as to extend inwardly towards the liquid-draining trough.

31. The treating device according to claim 30, wherein the treating trough has two the liquid-draining troughs, under each of which one liquid-conducting trough is arranged correspondingly, each liquid-conducting trough being supported and fixed by one respective pair of guides.

32. The treating device according to claim 17, wherein both the liquid-draining trough and the liquid-conducting trough are arranged along the direction of the pivot.

33. The treating device according to claim 17, wherein the treating trough has two sunken parts arranged in parallel, said liquid-draining trough is arranged at the bottom of each sunken part.
